(19) United States
(12) Patent Application Publication
(10) Pub. No.: US 2019/0354366 A1
(43) Pub. Date: Nov. 21, 2019

(54) METHOD AND SYSTEM FOR PERFORMING FIRMWARE UPDATE THROUGH DFU SUCCESS RATE PREDICTION MODEL

(71) Applicant: Tymphany Acoustic Technology (Huizhou) Co., Ltd., Huizhou City (CN)

(72) Inventors: Yick Hong LAM, Huizhou City (CN); Xudong LIU, Huizhou City (CN)

(21) Appl. No.: 16/415,673

(22) Filed: May 17, 2019

(30) Foreign Application Priority Data
May 17, 2018 (CN) 201810471793.3

(51) Int. Cl. G06F 8/654; H04L 29/08

(52) U.S. Cl. CPC G06F 8/654; H04L 67/34

(57) ABSTRACT

A method and system for performing firmware upgrade through DFU success rate prediction model includes inputting information of a target device to an external device or the external device automatically collecting the information, and triggering an operating system of the external device to perform the firmware upgrade; the external device issuing a firmware upgrade request to a server terminal, which inputs parameters from the external device to the prediction model to predict a success rate of the external device performing the firmware upgrade after receiving the query; and the server terminal returning to the external device a response whether to initiate a firmware upgrade. The present invention performs success rate evaluation according to the model information before upgrading the firmware, initiates the firmware upgrade or notifies the user about the risk of the bad result, and effectively reduces a brick probability of the target device when the firmware is upgraded.

This application claims priority of Application No. CN 201810471793.3 filed in China on May 17, 2018 under 35 U.S.C. § 119, the entire contents of all of which are hereby incorporated by reference.

### TECHNICAL FIELD

The present invention relates to the field of computer technologies, in particular, to a method and system for performing firmware upgrade through device firmware upgrade (DFU) success rate prediction model.

### BACKGROUND

For embedded devices that lack sufficient memory to back up existing firmware, firmware updates for the device are typically performed by directly allowing the external device to write new firmware to the flash. This firmware update method has a very obvious potential problem. That is, if the connection fails during the update process, the target embedded device will be locked.

In the prior art, the firmware upgrade of the embedded device is often performed through a Bluetooth connectivity. There are many shortcomings in the Bluetooth connectivity, such as the weak Bluetooth signal in the long range and the insufficient RF design of the mobile phone. In summary, the use of Bluetooth connectivity to complete firmware upgrades has a high failure rate.

### SUMMARY

In view of the above technical problems, the present invention provides a method and system for performing firmware upgrade through a DFU success rate prediction model, which effectively reduces the failure rate of the target device during firmware upgrade.

In order to solve the above technical problem, the technical solution provided by the present invention provides a method for performing firmware upgrade through DFU success rate prediction model, the method includes: a user inputting information of a target device to an external device or the external device automatically collecting the information of the target device, and triggering an operating system of the external device to perform the firmware upgrade; the external device issuing a firmware upgrade request to a server terminal, the server terminal inputting parameters provided by the external device to the DFU success rate prediction model to predict a success rate of the external device performing the firmware upgrade after receiving the query; and the server terminal returning to the external device a response whether to initiate a firmware upgrade.

Preferably, the DFU success rate prediction model predicts the success rate through a multiple regression calculation method.

Preferably, the information includes a device model, an OS version, an RSSI signal, a transmission type, an MTU size, and a time that the device has been used. It is used to simulate the relationship between scalar dependent variable and one or more independent variables for using information data by multiple regressions to predict a success rate and form a DFU success rate prediction model.

Preferably, the parameters include the information of the target device and the information of the external device.

Preferably, the server terminal returning to the external device a response whether to initiate a firmware upgrade includes the server terminal returning a response for initiating the firmware update to the external device, the external device directly initiating writing a new firmware to a flash memory of the target device during the firmware upgrade; and the server terminal returning a response for not initiating the firmware upgrade to the external device, the external device notifying the user of the risk of performing the firmware upgrade.

Preferably, the server terminal returning to the external device a response whether to initiate a firmware upgrade includes the external device issuing a firmware upgrade performance result and an input information to the server terminal, the server terminal using a cloud storage technology to store the firmware upgrade result and the input information in a database, which is useful for reference purposes when subsequent firmware upgrades are performed on other target devices.

The present invention further provides a system for performing firmware upgrade through DFU success rate prediction model, comprising an external device, a target device and a server terminal; the external device is used to predict a success rate of performing the firmware upgrade and directly initiates writing the new firmware to the flash memory of the target device during the firmware upgrade, and the server terminal is used to make a decision whether to initiate the firmware upgrade of the target device. When the firmware is upgraded, the target device does not have a network connection, and the external device receives or sends data from the server.

Preferably, the system further comprises a database for storing the firmware upgrade result and the input information, which is useful for reference purposes when subsequent firmware upgrades are performed on other target devices.

Compared with the prior art, the present invention provides several beneficial effects First, the present invention performs a success rate evaluation based on model information before upgrading the firmware, and initiates a firmware upgrade or notifies the user of the risk of adverse outcomes, so that the chance of brick is effectively reduced when the target device is upgraded during firmware upgrade;

Second, the external device issues a firmware upgrade performance result and input information to the server terminal, and stores them in a database, which is useful for reference purposes when subsequent firmware upgrades are performed on other target devices.

### BRIEF DESCRIPTION OF THE DRAWINGS

FIG. 1 is a flowchart of a method according to Embodiment 1 of the present invention; and

FIG. 2 is a block diagram of an overall system according to Embodiment 2 of the present invention.

### DETAILED DESCRIPTION

For a detailed description of the technical solutions of the present invention, the technical solutions of the embodiments of the present invention will be clearly and completely described below in conjunction with the accompanying drawings. It is apparent that the described embodiments are a part of the embodiments of the present invention, instead of all the embodiments. Based on the described embodiments of the present invention, all the other embodiments obtained by those of ordinary skill in the art without inventive effort are within the scope of the present invention.

### Embodiment 1

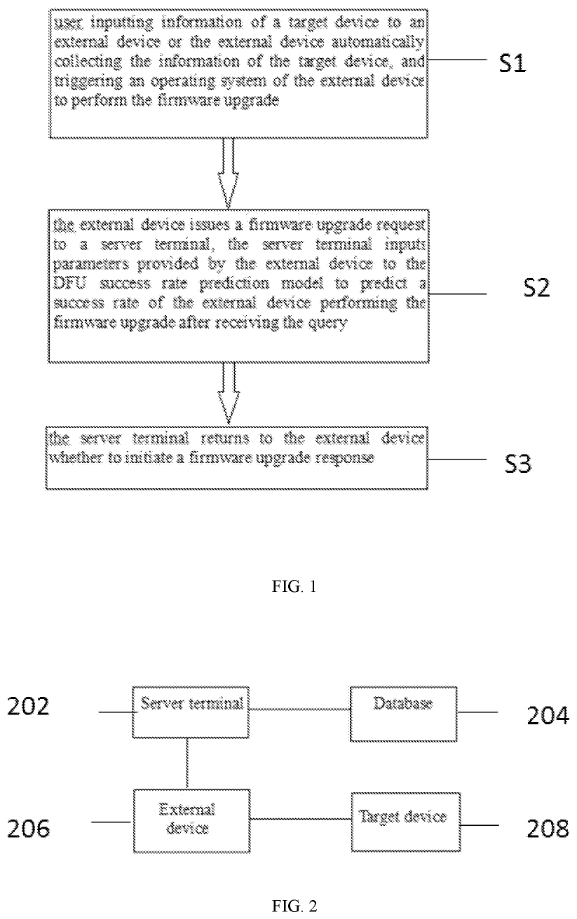

With reference to FIG. 1, the method for performing firmware upgrade through DFU success rate prediction model is provided by the present embodiment, the method comprising steps of: S1, a user inputting information of a target device to an external device or the external device automatically collecting the information of the target device, and triggering an operating system of the external device to perform the firmware upgrade; S2, the external device issuing a firmware upgrade request to a server terminal, the server terminal inputting parameters provided by the external device to the DFU success rate prediction model to predict a success rate of the external device performing the firmware upgrade after receiving the query; S3, the server terminal returning to the external device whether to initiate a firmware upgrade response.

The DFU success rate prediction model in step S2 of the present embodiment predicts the success rate through multiple regression for simulating the relationship between the scalar dependent variable and one or more independent variables, such as Y success rate =dependent variable, b device model=related factors, X device model=independent variable, Y success rate=b success constant+b device model X device model+bOS version XOS version+bRSSI signal XRSSI signal+. . . . The present invention collects each information data through a third-party software tool, calculates the prediction success rate through multiple regressions, and forms a DFU success rate prediction model.

The information in the step S1 includes a device model, an OS version, an RSSI signal, a transmission type, an MTU size, and a time that the device has been used, and the parameters in the step S2 include the information of the target device and the information of the external device in the step S1. Each of information data is calculated by multiple regressions to predict the success rate, and the DFU success rate prediction model is formed, so as to realize the subsequent DFU success rate prediction.

As a further preferred solution, the step S3 of the present embodiment specifically includes processes of: S31, the server terminal returning a response for initiating the firmware update to the external device, the external device directly initiating writing a new firmware to a flash memory of the target device during the firmware upgrade; S32, the server terminal returning a response that does not initiate the firmware upgrade to the external device, the external device notifying the user of the risk of performing the firmware upgrade.

It should be noted that the success rate base may be preset. For example, when the success rate is greater than or equal to 75%, the firmware upgrade is initiated; when the success rate is less than 75%, the firmware upgrade is not initiated and the user is notified of the risk of performing a firmware upgrade.

The step S3 further includes processes of: the external device issuing a firmware upgrade performance result and an input information to the server terminal, the server terminal using a cloud storage technology to store the firmware upgrade result and the input information in a database, which is useful for reference purposes when subsequent firmware upgrades are performed on other target devices.

### Embodiment 2

With reference to FIG. 2, the present embodiment provides a system for performing firmware upgrade through DFU success rate prediction model, comprising an external device 206, a target device 208 and a server terminal 202; the external device 206 is used to predict a success rate of performing the firmware upgrade and directly initiates writing the new firmware to the flash memory of the target device 208 during the firmware upgrade, and the server terminal 202 is used to make a decision whether to initiate the firmware upgrade of the target device 208. When the firmware is upgraded, the target device 208 does not have a network connection, and the external device 206 receives or sends data from the server.

Specifically, in the present embodiment, a user inputs information of a target device 208 to an external device 206 or the external device 206 automatically collecting the information of the target device 208, and triggers an operating system of the external device 206 to perform the firmware upgrade; S2, the external device 206 issues a firmware upgrade request to a server terminal 202, the server terminal 202 inputs parameters provided by the external device 206 to the DFU success rate prediction model to predict a success rate of the external device 206 performing the firmware upgrade after receiving the query; S3, the server terminal 202 returns to the external device 206 whether to initiate a firmware upgrade response.

When the success rate reaches a set range, for example, the success rate is set to be greater than or equal to 75%, the firmware update is initiated, and the server terminal 202 returns a response for initiating the firmware update to the external device 206, the external device 206 directly initiating writing a new firmware to a flash memory of the target device 208 during the firmware upgrade; when the success rate is less than 75%, the server terminal 202 returns a response that does not initiate the firmware upgrade to the external device 206, and the external device 206 notifies the user of the risk of performing the firmware upgrade.

As a further preferred solution, the system for performing firmware upgrade through DFU success rate prediction model provided by the present embodiment further comprises a database 204 for storing the firmware upgrade result and the input information, which is useful for reference purposes when subsequent firmware upgrades are performed on other target devices.

Regardless of whether the firmware upgrade is initiated or not, after the completion of success rate prediction, the external device 206 issues a firmware upgrade performance result and an input information to the server terminal 202, and the server terminal 202 uses a cloud storage technology to store the firmware upgrade result and the input information in a database 204, which is useful for reference purposes when subsequent firmware upgrades are performed on other target devices.

The above description is only examples and illustrative of the structure of the present invention, and the description thereof is more specific and detailed, but is not to be construed as limiting the scope of the present invention. It should be noted that it will be apparent to those skilled in the art that various modifications and improvements can be made without departing from the spirit and scope of the present invention. These obvious alternatives are all within the scope of the present invention.

1. A method for performing firmware upgrade through device firmware upgrade (DFU) success rate prediction model, comprising:
a user inputting information of a target device to an external device or the external device automatically collecting the information of the target device, and triggering an operating system of the external device to perform the firmware upgrade;
the external device issuing a firmware upgrade request to a server terminal, the server terminal inputting parameters provided by the external device to the DFU success rate prediction model to predict a success rate of the external device performing the firmware upgrade after receiving the query; and
the server terminal returning to the external device a response whether to initiate a firmware upgrade.

2. The method for performing firmware upgrade through DFU success rate prediction model according to claim 1, wherein the DFU success rate prediction model predicts the success rate through a multiple regression calculation method.

3. The method for performing firmware upgrade through DFU success rate prediction model according to claim 1, wherein the information in user inputting information includes a device model, an OS version, an RSSI signal, a transmission type, an MTU size, and a time that the device has been used.

4. The method for performing firmware upgrade through DFU success rate prediction model according to claim 3, wherein the parameters in said issuing a firmware upgrade request include the information of the target device and the information of the external device.

5. The method for performing firmware upgrade through DFU success rate prediction model according to claim 1, wherein said returning to the external device a response whether to initiate the firmware upgrade comprises:
the server terminal returning a response for initiating the firmware update to the external device, the external device directly initiating writing a new firmware to a flash memory of the target device during the firmware upgrade; and
the server terminal returning a response for not initiating the firmware upgrade to the external device, the external device notifying the user of the risk of performing the firmware upgrade.

6. The method for performing firmware upgrade through DFU success rate prediction model according to claim 1, wherein said returning to the external device a response whether to initiate the firmware upgrade comprises: the external device issuing a firmware upgrade performance result and an input information to the server terminal, the server terminal using a cloud storage technology to store the firmware upgrade result and the input information in a database.

7. A system for performing firmware upgrade through DFU success rate prediction model comprising:
a target device;
an external device configured to predict a success rate of performing the firmware upgrade and directly initiate writing the new firmware to the a flash memory of the target device during the firmware upgrade; and, a server terminal configured to make a decision whether to initiate the firmware upgrade of the target device.

8. The system for performing firmware upgrade through DFU success rate prediction model according to claim 7, further comprising a database for storing the firmware upgrade result and the input information.
